(19) United States
(12) Patent Application Publication
(10) Pub. No.: US 2003/0170006 A1
(43) Pub. Date: Sep. 11, 2003

(54) Versatile video player

(76) Inventors: Peter B. Bogda, Dallas, TX (US); Aleksey Bragin, Moscow (RU); Oliver G. Graham III, Ft. Worth, TX (US); Alexis P. Shelokov, Dallas, TX (US)

Correspondence Address: INNOVAR, LLC, P O BOX 250647, PLANO, TX, 75025, US

(21) Appl. No.: 10/093,852

(22) Filed: Mar. 8, 2002

(51) Int. Cl. H04N 5/781

(52) U.S. Cl. 386/96; 386/125

(57) ABSTRACT

The invention includes a versatile video player application, system and method for playing video files stored on a removable CD. The invention permits a user computer to play video files even though the user computer may not have a specified video enhancer or video renderer installed in its operating system or even though the specified video enhancer or video renderer is improperly installed. As it does not require installation of files into the user computer operating system, the video player does not require IT intervention in local networks where the user's operating activities are restricted, thus posing no compromise of security on the users system nor the network the system resides on. The invention provides a compact disc comprising at least one video file to be played, a video player application, at least one optional target content file, and at least one video player application extension adapted to utilize a video renderer application extension in the OS of the user computer. The video player application comprises a video decoder routine, audio decoder routine, a graphical user interface routine and an optional video performance optimization routine. The video player application also utilizes a number of specified “always-present” application extensions located in the operating system of the user computer.

### FIELD OF THE INVENTION

The present invention concerns a video player application, system and method. More particularly, the invention concerns a versatile video player application, system and method useful for playing video and audio data stored on an optical disk.

### BACKGROUND OF THE INVENTION

Currently available video player applications require that they be installed into the operating system of a user computer in order for the computer to play a video file installed on a removable optical disk such as a DVD or CD. Multi Media®, Real Player®, and QuickTime® are examples of such a video player program. Proper operation of these video player programs, for operating system platforms such as Windows®, Unix® and Apple®, for example, requires installation of certain files into the system folder. For example, Windows® video player applications generally require a hard disk installed executable file that controls the overall operation of program, a hard disk installed rendering routine (program or subroutine) to actually render each frame of a video file, a hard disk installed decoder routine (or program or subroutine) that decodes the digital data and several hard disk installed dynamically linked library (“DLL”) files or application extensions.

With increasing frequency, advertisers are employing video files in their CD-based advertisements. Currently available video player programs, however, often encounter incompatibility problems when attempting to play video files on removable CD's. For example, video files on DVDs generally require a particular version of the DirectX® API, or some equivalent, to be installed on a user computer in order to play the video files. Unfortunately, a user computer might have an outdated version of the DirectX® API installed or might have the DirectX® API incorrectly installed. Since currently available video players programs require preinstallation onto the hard disk or operating system of the user computer, the computer will be unable to play the video file on the DVD or CD. Therefore, a user will not be able to view the intended video advertisement.

A need remains for a versatile video player application, system or method that does not require preinstallation of all of its components onto the hard disk or operating system of a user computer in order for the video player application to function properly. A need also remains for a video player system that can play a video file on a removable CD even though the user computer into which it is loaded does not include a completely installed video player program per se. None of the known art discloses such a video player program.

### SUMMARY OF THE INVENTION

The present invention seeks to overcome some or all of the disadvantages inherent in the video player applications and systems of the art. The present invention provides a video player application and system that can play a video file (MPEG3-4 or AVI) on a removable CD even though the user computer with which the video player program is run does not have all of the components of the video player application installed onto its hard disk. The present video player system includes a CD having a video player application stored therein. The video player system is an adaptable cross-platform system that can be tailored to function with different operating systems so that one CD can be used to play video files on one or two or more different operating system environments (platforms).

One aspect of the invention provides a compact disc comprising:

a video player application comprising a video decoder routine, an audio decoder routine, a graphical user interface routine and a video performance optimization routine;

one or more video player application extensions that include video and audio rendering interface functions; and

one or more video files.

Specific embodiments of the system include those wherein: 1) the video player application and application extensions are tailored for operation in a WINDOWS® operating system environment; 2) the video decoder routine is based upon MPEG-4 digital video compression standards and file formats; 3) the video player application, when running, provides a graphical user interface on the display monitor of the user computer into which the compact disc is installed (loaded); 4) the compact disc further comprises an AUTORUN routine that initializes the video player application after loading of the compact disc into the user computer; 5) the video performance optimization routine optimizes the performance parameters for playing the video file(s) on a user computer by analyzing the content of the CD and by analyzing the hardware, software and settings of the user computer; 6) the compact disc further comprises one or more audio files; 7) the compact disc further comprises one or more text files; 8) the video performance optimization routine determines the presence or absence of a predefined video renderer application extension in the OS of a user computer into which the compact disc is loaded; 9) the one or more video player application extensions comprises a first video player application extension for use when a predefined video renderer is present in the OS of a user computer into which the compact disc is loaded and a second video player application extension for use when the predefined video renderer is absent from the OS of a user computer into which the compact disc is loaded; 10) the first video player application extension is used when the DirectX® API is present in the OS of the user computer, and the second video player application extension is used when the DirectX® API is absent from the OS of the user computer; 11) the second video player application extension is GDI-based; 12) the audio decoder routine is based upon MP-3 digital or ACM audio compression standards file formats; 13) the first video player application extension is DirectX®-based; 14) the compact disc further comprises one or more HTML (hypertext markup language format) files for which are created corresponding active links in the GUI of the video player application when running; 15) the video file includes audio data; 16) the VP application includes decoder functions to decode MP3 files; 17) the first video player application extension references a DirectDraw component of the DirectX® API and a GDI video renderer, and the second video player application extension references a GDI video renderer; 18) the video player application includes references to one or more predefined “always present” application extensions in the operating system of the user computer.

Another aspect of the invention provides a method of playing one or more video files, the method comprising the steps of:

a user computer reading and enabling a video player application obtained from a CD containing video files to be played, wherein the video player application is not installed in the hard disk of the user computer;

the video player application determining the optimum video performance parameters for playing the video file(s) on the user computer by analyzing the content of the CD, by analyzing the hardware, software and settings of a user computer into which the CD has been installed (loaded), and by determining the presence or absence of a predefined video enhancer application extension in the OS of the user computer;

initializing an “always present” predefined video renderer application extension and the predefined video enhancer application extension, if present in the OS of the user computer, or, if the first predefined video enhancer application extension is absent from the OS of the user computer, initializing an “always present” predefined video renderer application extension;

initializing a video player application extension obtained from the CD and initializing other application extensions obtained from the operating system of the user computer, wherein the video player application extension from the CD is adapted for use with the predefined video renderer and optionally video enhancer application extension that is initialized;

initializing a video decoder routine from the video player application or the user computer;

defining and creating a graphical user interface, wherein definition of the GUI depends upon the determined optimum video performance parameters; and

reading and playing one or more video files obtained from the CD comprising the video player application.

Specific embodiments of the invention also include those wherein: 1) the method further comprises the step of enabling the video player application by using an autorun routine; 2) the step of determining the optimum video performance parameters comprises the steps of setting the color resolution of the display monitor to a determined setting; 3) the step of defining and creating a graphical user interface comprises the steps of: creating a framework for a GUI according to information obtained from the registry entries of the user computer; optionally searching for one or more target content files on the CD and creating GUI buttons (active links) associated with said target content files; and displaying a GUI; 4) the step of reading and playing one or more video files comprises the steps of: selecting a video file to be played; reading the video file into memory; optionally determining whether or not audio data is associated with the video file; establishing a process thread for the video thread function if there is no audio data associated with the video file or establishing a process thread for the video/audio thread function if there is associated audio data; initiating the play cycle of the video file and optionally of the audio data, if any; displaying the video file frames and optionally in synchronization outputting the corresponding audio data segments, if any; ending the play cycle of the video file; and optionally determining whether or not another video file has been selected for playing; 5) the method further comprises the optional step of repeatedly playing the video file and associated audio data, if any; 6) the method further comprises the step of determining whether or not the user has activated “forward” or “reverse” commands, and if so, seeking the selected video keyframe position and selected audio segment, if any; 7) the method further comprises the step of terminating the video player application if no additional video file is to be played; and/or 8) the method further comprises the step of determining whether or not the user has activated the “stop” or “pause” commands.

Another aspect of the invention includes a video player system comprising:

a compact disc comprising a video player application, at least one video player application extension that provides video rendering interface related functions accessible by the video player application when running, and at least one video file to be played, wherein the video player application comprises a video decoder routine, audio decoder routine and graphical user interface routine, and at least one of the video player application extensions is adapted to draw upon a predefined video renderer application extension in the operating system of a user computer; and

a user computer comprising an operating system, video adapter, display monitor, and optional audio adapter, wherein the operating system comprises at least one predefined video renderer application extension and optionally at least one video enhancer application extension, each application extension being accessible to the at least one video player application extension;

wherein the video player application operates without requiring installation of any files into the operating system of the user computer.

Specific embodiments of the invention include those wherein: 1) the at least one video player application extension comprises a first video player application extension for use when a first predefined video renderer application extension is present in the OS of the user computer and a second predefined video player application extension for use when a second predefined video renderer application extension is present in the OS of the user computer; 2) the predefined video enhancer application extension is the DirectDraw® application extension and the predefined video renderer application extension is the GDI application extension; 3) the video player application further comprises a video performance optimization routine; 4) the OS of the user computer further comprises at least one audio renderer application extension; 5) other specific embodiments of the invention are included herein.

One embodiment of the invention provides a compact disc adapted to being played in a computer operating under the Windows® operating system environment, the compact disc comprising:

a video player application comprising a video decoder routine, an audio decoder routine, a graphical user interface routine, a video performance optimization routine, and at least one import request for one or more always-present DLL files in the Windows operating system;

a first DLL file comprising import requests for the DDRAW.DLL, DDRAWEX.DLL or DDRAW16.DLL file and the DSOUND.DLL or DSOUND3D.DLL file of the Windows® operating system;

a second DLL file comprising import requests for the GDI32.DLL file of the Windows® operating system;

one or more video files stored in the memory of the compact disc.

Specific embodiments of the invention also include those wherein: 1) the compact disc further comprises one or more target content files; 2) the first DLL file further comprises an import request for the GDI32.DLL file of the Windows® operating system; 3) the first and second DLL files further comprise import requests for the WINMM.DLL, KERNEL32.DLL, and USER32.DLL files of the Windows® operating system; 4) the compact disc further comprises an AUTORUN routine that initializes the video player application when the compact disc is loaded into a user computer; 5) the video decoder routine uses a video resource selected from the group consisting of MPEG-1, MPEG-2 and MPEG-4; 6) the audio decoder routine uses an audio resource selected from the group MP3; 7) the VP application comprises a search routine to determine if target content files are stored in the disc; 8) the VP application includes a routine that determines whether or not the DDRAW.DLL, DDRAWEX.DLL or DDRAW16.DLL file is present in the OS of a user computer into which the CD is loaded; 9) the VP application includes a search routine to determine if HTML files are stored in the disc; 10) the VP application comprises a routine that determines whether or not the DSOUND.DLL or DSOUND3D.DLL file is present in the OS of a user computer into which the CD is loaded; 11) the memory of the compact disc further comprises audio data; and/or 12) the GUI routine includes functions to create button (active links) associated with target content files stored on the CD or user computer.

### BRIEF DESCRIPTION OF THE FIGURES

The following figures form part of the present description and describe exemplary embodiments of the claimed invention. The skilled artisan, in light of these figures and the description herein, will be able to practice the invention without undue experimentation.

FIG. 1 depicts a generalized logic flowchart of one embodiment of the video player application of the invention.

FIGS. 2A-2E depict a logic flowchart of another embodiment of the video player application of the invention and of its components

FIG. 3 depicts an exemplary GUI created when running the video player application.

### DETAILED DESCRIPTION OF THE INVENTION

The video player application, system and method use a combination of files from the CD and from the OS of the user computer. By using the files in this manner, the video player (VP) application is able to operate even when the user computer does not have a first predefined video renderer installed in its OS or has a first predefined video renderer improperly installed in its OS. The VP application can play audio and video files obtained from the CD onto which the VP application is stored, from the memory of the user computer or from a network such as the Internet. The VP application, system and method can be tailored for operation with any OS environment including, for example, Windows®, Apples®, and Unix®. It should be noted that the VP application can be adapted to operate with any API-based operating system. The Windows® operating system refers to any such operating system including and newer than the Windows® 95 operating system, e.g., Windows® 98, Window^{S}® 98 SE (second edition), Window^{S}® 2000, Window^{S}® NT, Window^{S}® OS/X and any other such operating system known to those of ordinary skill in the art.

As used herein and unless otherwise defined, the term CD or compact disc refers to a removable optical data storage disk or DVD (digital video disc or digital versatile disc, which is a type of CD-ROM optical data storage disk). These devices also include CD-R and CD-RW discs.

As used herein, the term install means to store a program or application on the hard disk of a user computer. In reference to a CD, the term install or load means to place the CD in the CD or DVD drive of a user computer. The CD or DVD drive can be an internal or external drive that is connected to the user computer either directly or indirectly or is accessible to the user computer by way of a network to which the user computer is connected.

The term run, when used in reference to a program, routine or other executable files, means to read the executable into the RAM or equivalent memory of the computer and to execute the commands in the program, routine or other executable file. As used herein, the term read means to copy data, such as a program or other file, to a place, e.g., the RAM, where it can be used by a computer. The term refers to copying data from a disk to the main memory of a user computer. As used herein, the term main memory refers to the physical memory that is internal to a computer. Main memory is distinguished from the mass storage devices such as the disk drives: hard drive, floppy drive, CD drive, etc. RAM (random access memory) is another term for main memory. Keep in mind, however, that some portion of the RAM can be available as cache memory, and that cache memory can be available as soft disk cache (general purpose RAM) or hard disk cache (part of the hard disk drive itself). The term cache refers to a high-speed storage mechanism that is used to speed up access to data on a disk. Cache can be either a reserved portion of system RAM or an independent high-speed storage device. Personal computers use memory caching and/or disk caching. During memory caching, a portion of memory comprising high-speed static RAM (SRAM) instead of dynamic RAM (DRAM) is used for the main memory. During disk caching, conventional main memory is used instead. That said, the video player program of the invention is copied into the RAM of a user computer, but it is not installed per se in the hard disk of the user computer.

As used herein, the term initialize refers to the process of starting up a program or routine or assigning a starting value to a variable.

As used herein, the term terminate refers to ending the running of a program.

The term video memory refers to RAM installed on a video adapter. The amount of video memory dictates the maximum resolution and color depth available. Some common types of video memory include VRAM, WRAM, RDRAM, and SGRAM.

A DLL file, which is also sometimes referred to as a multi-function file or an application extension, provides one or more particular functions, and a program accesses the functions by creating either a static or dynamic link to the file. A static link remains constant during program execution, while a dynamic link is created by the program as needed. DLL files can also contain just data. DLL files usually end with the extension .dll, .exe, .drv, or .fon. A DLL can be used by several applications at the same time. Some DLLs are provided with the Windows® operating system and are available for any Windows® application. These DLLs are referred to as “always-present” DLL files. Exemplary always-present DLL files include WINMM.DLL (from Windows® Multimedia®; 32-bit DLL that provides multimedia functions for handling sound, music, real-time video, sampling and other functions; 16-bit equivalent is MMSYSTEM.DLL), KERNEL32.DLL (handles memory management, multitasking of programs that are running and other functions which directly affect how Windows® runs), USER32.DLL (Windows® management library that contains functions which deal with menus, timers, communications, files and other non-display areas of Windows®), GDI32.DLL (provides the necessary functions to draw things on the display monitor screen, as well as checking which areas of forms need to be redrawn), MSACM32.DLL (Microsoft® audio compression manager; an audio renderer application extension), SHELL32.DLL (provides Object Linking and Embedding (OLE) drag and drop routines), OLE32.DLL, and COMDLG32.DLL. Some of these always-present DLL files are used by the VP system of the invention as described below. If the DirectX® API is installed in a user computer, the DDRAW.DLL and DSOUND.DLL files are present in the OS system of the computer.

An API provides the building blocks necessary to develop a program. An API is a set of routines, protocols and tools for building software applications. DirectX® is a set of API's (Application Program Interfaces) that enables programmers in the Windows® environment to write programs that access hardware features of a computer without knowing exactly what hardware will be installed on the machine where the program eventually runs. The DirectX® API achieves this by creating an intermediate layer that translates generic hardware commands into specific commands for particular pieces of hardware. The Windows® operating environment provides the DirectX® API so that programmers can write applications that are consistent with the operating environment. When installed on a user computer operating under the Windows® environment, the components of DirectX® are included within the OS of the computer. DirectX® includes the DirectSound® and DirectDraw® components at a minimum and can also include other related components.

DirectDraw® is a software interface standard for transferring video processing from a PC's CPU to the video adapter. The DirectDraw® program includes several functions that enhance the rendering of a video file by a video renderer application extension. It is an exemplary “video enhancer application extension”, as described herein. A video enhancer application extension enhances the performance of a video renderer application extension or video renderer program. DirectDraw® enhance the functions of the GDI video renderer application. This standard was initially called Display Control Interface (DCI). When the CPU is not busy, the Windows® GDI updates the video display. If the CPU is busy, the DCI driver allows an application to send update information directly to the video adapter.

DirectSound® and DirectSound3D® API software interfaces are subsets of DirectX® that handle playing waveaudio data. These packages can include software components such as TMMDSWaveOut, TMMDSEditor, TMMDSWaveChannel, TMMDSMIDIChannel, TMMDSConnector, and TMMDSWaveMixer. The video player application need not use all of these components. DirectSound® provides support for playing MP3 formatted files. The DirectSound® program is an audio enhancer application extension. DirectSound® enhances the audio rendering capabilities of theMSACM32.DLL audio renderer application extension.

In order for a computer to display a video file on (output a video file to) a monitor, the computer must have a video adapter, which is also referred to as a video card, video board, video display board, graphics card or graphics adapter. The display capabilities of computer depend upon its software, logic circuitry and the display monitor. Many different types of video adapters are available for computers and most conform to one of the standards defined by VESA or IBM. Any suitable video adapter can be used in the VP system of the invention. The computer must also have a video renderer and a video decoder accessible to its operating system.

A decoder is a device or program that translates encoded data into its original format (e.g., it decodes the data). A decoder decodes video and/or sound data before it is output to the display monitor or speakers. For example, a video decoder will decode MPEG data before it is output to a display monitor. In one embodiment, the video decoder routine is based upon MPEG technology. Moving Picture Experts Group (MPEG) is a family of digital video compression standards and file formats. MPEG achieves high data compression rates by storing only the changes from one frame to another instead of each entire frame in a video sequence. The data is then compressed using a lossy compression algorithm, which is a data compression technique in which some amount of data is lost due to attempts to eliminate redundant or unnecessary information. There are three MPEG standards: MPEG-1, MPEG-2 and MPEG-4. MPEG-4 is a graphics and video standard that is based on MPEG-1 and MPEG-2 and Apple QuickTime® technology. Wavelet-based MPEG-4 files are designed to transmit video and images over a narrower bandwidth and can mix video with text, graphics and 2-D and 3-D animation layers. MPEG is used as a video decoder in the present system; however, other video decoders can be used.

Graphical Device Interface (GDI; a video renderer) is a Windows® standard for representing graphical objects and transmitting them to output devices such as a display monitor or a printer. Rendering refers to the process of adding realism to a graphic file by adding three-dimensional qualities such as shadows and variations in color and shade. One technique for rendering graphics is called ray tracing. Another type of rendering is scanline rendering, which renders images one vertical line at a time instead of object-by-object as in ray tracing.

In order for a user computer to play an audio stream, it must have audio resources such as an audio adapter (sound card etc.) and it must have access to an audio decoder and audio renderer. An audio decoder routine is embedded within the VP application. In one embodiment, the audio decoder is based upon MP3 or WAV technology; however, if other file formats are to be played, then the VP application can employ an audio decoder and audio resources installed in the user computer. When the compact disc contains the MP3 decoder technology, it will include conventional MP3 files such as the COMMON.CPP (provides common functions used in MP3 decoding), DCT64_I386.CPP (provides discrete cosine transform routines), DECODE_{—}1386.CPP (audio decoder for MPEG layers 1,2,3), INTERFACE.CPP (provides interface functions between the VP application and the MP3 decoder), RING.CPP (provides ring type audio queue), TABINIT.CPP (initializes data for decoder tables), and the actual audio decoders LAYER1.CPP, LAYER2.CPP and LAYER3.CPP. If a predefined audio renderer is present in the OS of the user computer, the VP application will use that audio renderer and the corresponding VP application extension that is tailored to operate with that audio renderer. For example, in a Windows® environment, the VP application searches for Direct®, or one of its components, in the OS of the user computer. If it is present and properly installed, the VP application employs the DirectSound® audio enhancer and the MSACM32.DLL audio renderer or any other audio renderer application extension being used. If DirectX® component is not found in or is otherwise unavailable to the OS of the user computer, the VP application employs the audio renderer embedded within the VP application extension containing it or it just uses the MSACM32.DLL audio renderer. If the audio data (stream) to be played is of a format not supported by either the VP application extension or the user computer, then the VP application will not play the audio portion of the video file but can still play the video data.

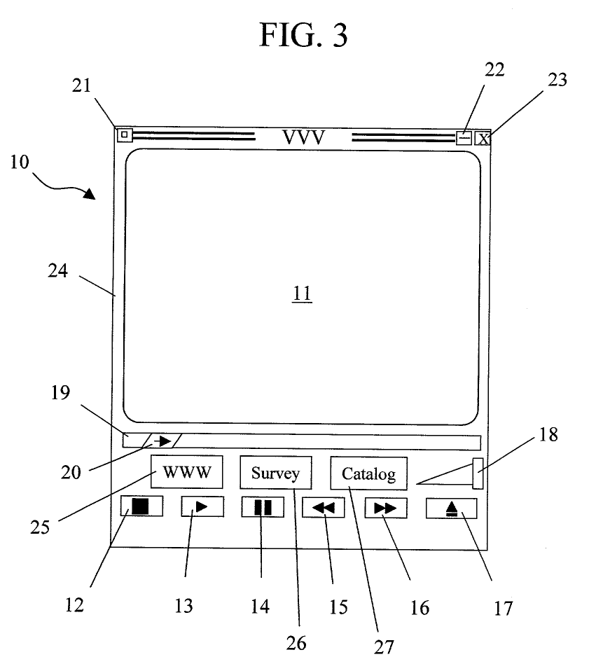

The GUI of the VP application is made to include features allowing a user to play, reverse, stop, pause, forward or scrub a particular video sequence. If the forward or reverse features are activated, the VP application seeks the selected key-frame (in the video sequence) and optionally the selected audio segment (in the corresponding audio file) and begins playing the video and audio segment, if any, from that point on in the direction indicated. If the pause feature is activated, the VP application temporarily pauses the play cycle for a video file at the selected video frame. Playback resumes after the user activates the pause command again or another command other than the stop command. If the stop feature is activated, the VP application ends the play cycle of the video file and reinitializes the commands of the GUI. Scrubbing refers to the process of moving within an audio or video file to locate a particular section. Many audio scrub tools today allow the user to drag a cursor across the wave form to audition different sections of an audio file. All such systems are useful with the VP application of the invention. In one embodiment, the scrub function is included in the GUI as a slide bar (19, 20 in FIG. 3). If the scrub feature is activated, the user is permitted to move within a video file and corresponding audio file to locate a particular section or frame of the file. The VP application can also include a file-marking routine that allows a user to begin playback at predefined locations within a video file. In one embodiment, the VP application comprises plural routines such as a video decoder routine, audio decoder routine, graphical user interface routine, input file routine, direct dialog routine, main routine, playlist routine, resizer routine, buffer routine, video buffer routine, reset routine, skin routine, audio renderer related routine, audio decoder related routine, video decoder related routine, video renderer related routine, playback routine, and other routines. While some of the functionality of the routine may overlap, each of the named routines has its own general function(s). The main routine provides the overall architecture of the video player application. It is the entry point of the VP application and conducts initialization, deinitialization and other supplemental functions. The resizer routine is used to draw a resizable skin for the window of the GUI as needed to reconcile the resolution of the video file with the resolution of the display monitor.

The buffer routine manages the memory resources and clears the buffer memory as needed.

An application is a program or group of programs. An application extension is a special feature or operation (routine or program) that has been added to an application to perform a function or several functions as part of the application. The term routine refers to a section of a program that performs a particular task. The term routine is generally synonymous with procedure, function and subroutine. A program consists of modules each of which contains one or more routines, and it is an organized list of instructions, that when executed, causes a computer to behave in a predetermined manner. A program contains a list of variables and a list of directions that tell the computer what to do with the variables. The variables can represent data, text or graphical images.

Resolution refers to the sharpness and clarity of an image and is used to describe monitors, printers and graphic images. For monitors, the screen resolution signifies the number of pixels on the entire screen. For example, a 640×480 pixel screen is capable of displaying 640 distinct pixels on each of 480 lines. This translates into different dpi (dots per inch) measurements depending upon the size of the screen. Increasing resolution in a display to its highest available setting is an optional part of optimizing the video performance parameters of the VP application. The size at which a particular video file is viewed will depend upon the color resolution of the display monitor and of the video file.

A graphical user interface (GUI) routine is a program interface that takes advantage of the computer's graphics capabilities to make the video player program easier to use. The GUI can include a pointer, icons, a desktop area, menus, active links, text and graphics. A pointing device such as a mouse or trackball is used to interact with the GUI to execute commands. Alternatively, a user can employ keystrokes to execute commands. The GUI routine of the VP application creates a GUI that a user uses to interact with the application. The buttons present in the GUI depend upon the programming of the GUI, the presence or absence of target content files on the CD and can also be shown or not shown based on presence of internet connectivity, hard code features in the VP application or vendor parameters in the autorun.ini routine.

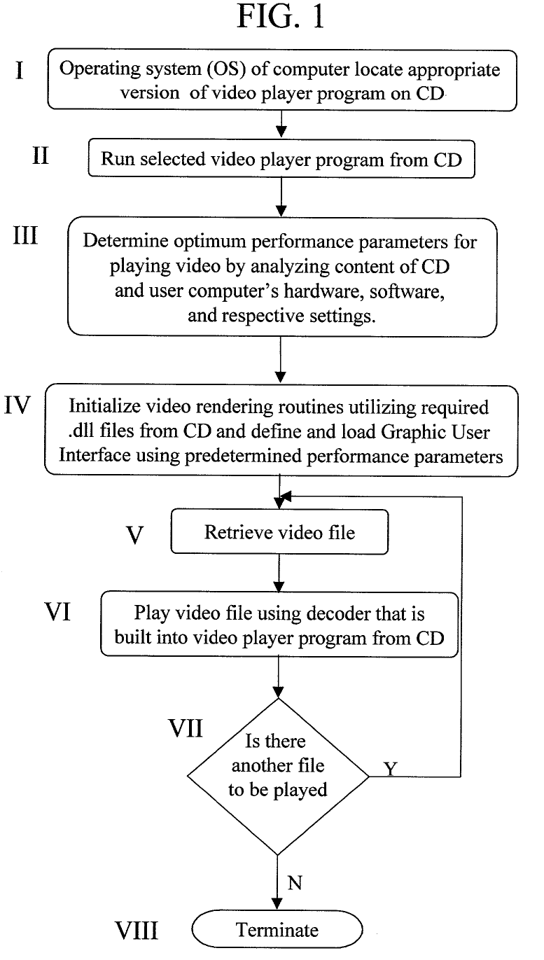

FIG. 1 depicts a general logic flowchart for operation of the video player application. In Step I, a compact disc containing the video player application is loaded into the CD (or DVD) drive of a user computer. Since many different operating systems are available, a CD can contain one, or two or more different versions of the VP application and its associated components. The computer then locates the appropriate version of the VP application that is compatible with the OS of the computer.

In Step II, the VP application is enabled by a user or automatically by the computer by way of an AUTORUN routine optionally included in the CD. When the AUTORUN routine is present, its content can be adapted to automatically open the VP application and a predefined video file on the CD. For example, an AUTORUN.INI file might include command lines such as:

[autorun]

open=vplayer.exe “video.avi”

In this example, VPLAYER.EXE is the name of the VP application and VIDEO.AVI is the name of the video file to be played. By virtue of this simple design, the content of the CD can be easily tailored merely by changing the name of the video file in the AUTORUN sequence and by changing the video file itself. Any HTML (target content) files to be included in the CD can also be easily changed. For example, a first advertiser might include the files VIDEO1.AVI, WEB1A.HTML, and WEB1B.HTML; whereas a second advertiser might only include the files VIDEO2.AVI and WEB2.HTML. In either case, the CD would still contain the VP application, its corresponding application extension(s) and the optional AUTORUN routine. A publisher and/or manufacturer of the CD could simply provide to an advertiser the CD loaded with its key components. The advertiser could then load the desired video file(s) and optional HTML file(s) onto the CD and modify the AUTORUN routine as needed and end out with a tailored CD comprising a VP application that plays a predefined video file and creates a predetermined GUI.

If no AUTORUN routine is included with the CD, a user can open the VP application by entering conventional commands through the keyboard or the desktop GUI of the computer.

Once enabled, the VP application determines the optimum video performance parameters for displaying a video file on the display monitor of the user computer. This determination in Step III is conducted by analyzing the contents of the CD to determine their video display requirements and by analyzing the hardware and software of the user computer to determine its video display capabilities and settings. Although described in greater detail below, this step generally regards optimization of the color resolution for the display monitor and determination of the video rendering capabilities of the user computer, e.g., determining the presence or absence of a predefined or specified application extension in the OS of the user computer.

In Step IV, the video rendering related resources are initialized. These include a predefined video enhancer application extension from the OS of the user computer, an always present video renderer application extension from the OS of the user computer, and a compatible VP application extension from the CD. The VP application extension (AE) used will depend upon whether or not the predefined video enhancer application extension is present in the OS. The VP application determines whether or not the predefined video enhancer AE is present in the OS of the computer, and, if so, whether or not it will function properly. If the predefined video enhancer AE is present and functions properly, then the VP application initializes a first VP AE, from the CD, that is compatible with it and it initializes an “always-present” predefined video renderer AE from the user computer. If the predefined video enhancer AE is absent or if it does not function properly, then the VP application initializes the “always-present” predefined video renderer AE from the user computer, and a second VP AE, from the CD, that is compatible with it. Since the predefined video renderer AE is always present in the OS of the user computer, then the VP application will be able to play the video file on the CD even though some of the video rendering resources of the user computer are not functioning properly. In other words, the VP application can function even though the video enhancer AE is absent, as long as the predefined video renderer AE is present.

The VP application then begins performing the underlying operations for creating and displaying a GUI by way of which a user interacts with the VP application. The initial framework of the GUI is built based upon the determined optimum video performance parameters, the video renderer AE being used, and the VP AE being used. The final GUI is created and displayed on the monitor after the VP application has determined whether or not additional buttons (active links) need to be added to it. This determination is based upon the presence or absence of target content file(s) on the CD and is detailed further below. As used herein, a target content file is an information data stream included on the compact disc, which data stream can include a text file, graphic file, database file, system executable file or other such data files. A target file is referenced in the AUTORUN routine or hard-coded in the VP application. Depending upon how the AUTORUN routine and/or VP application are programmed, the GUI routine creates one or more active buttons on the GUI for each target content file included in the compact disc. For example, FIG. 3 depicts the “WWW”, “Catalog” and “Survey” active buttons, which correspond to respective HTML formatted target content files included in a compact disc.

Step V in FIG. 1 begins with the selection of a video file to be played. The selection can be done by a user using GUI, voice or keyboard commands or automatically by the VP application. Since the VP application can include the “recent files menu” from the user computer as well as the playlist of the CD, any video file included in these can be played by the application. After selection, the video file is read into the memory of the computer and the window of the GUI is sized according to the resolution and aspect ratio of the video file. For example, if a system is set to a resolution of 1024×768, and the video file resolution is 640×80, then the video is drawn at a size of 640×480 but the system still maintains its 1024×768 resolution. The system size/resolution is only changed if needed to perform good video playing presence. However, if the resolution of the video file is 1024×768, its aspect ratio is one and the resolution of the display is set to 640×480, then the window of the GUI is increased in size to match the resolution of the video file.

The audio requirements of the video file are then assessed by determining whether or not the video file has audio data associated with it. The audio data can be part of the video file. The VP application then calls upon audio resources (from the CD and OS of the user computer) as needed and establishes a thread function for the video file. As used herein, a thread is a part of a program, e.g., a series of operations that can execute independently of other parts of that program. If audio data is available, and the operating system has audio support installed, the thread function includes audio and video operations. If no audio data is available, the thread function includes only video operations. The VP AE functions as an audio renderer interface and relies upon an audio renderer routine included in the VP AE or upon an “always present” audio renderer AE in the OS of the user computer.

Play of the video file begins in Step VI of FIG. 1. The VP application employs a video decoder included within it, an audio decoder included within it, a video renderer AE from the OS of the computer, an audio renderer AE from the OS of the computer, a VP AE included with the CD, and other AEs from the OS of the computer. The audio components are used only as needed. The video file is output to the display monitor on a frame-by-frame basis.

After completion of playing the video file, the VP application then determines whether or not another video file is to be played and/or whether or not the same video file should be repeated. The VP application can be programmed to automatically play a second or more video files. Alternatively, a user might choose to play a second video file. They can choose from the Last Used Files list in the program, or select from their own hard drive. The VP application can also be programmed to repeatedly play the first video file a specified or unspecified number of times. Likewise, the VP application can be programmed to play two or more video files in sequence.

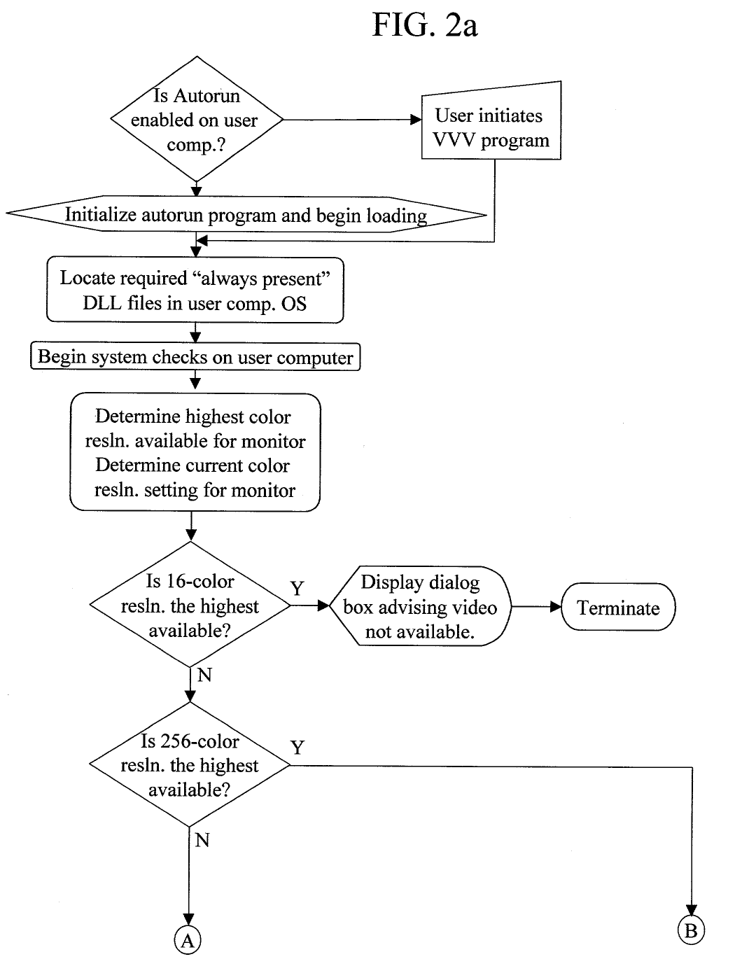

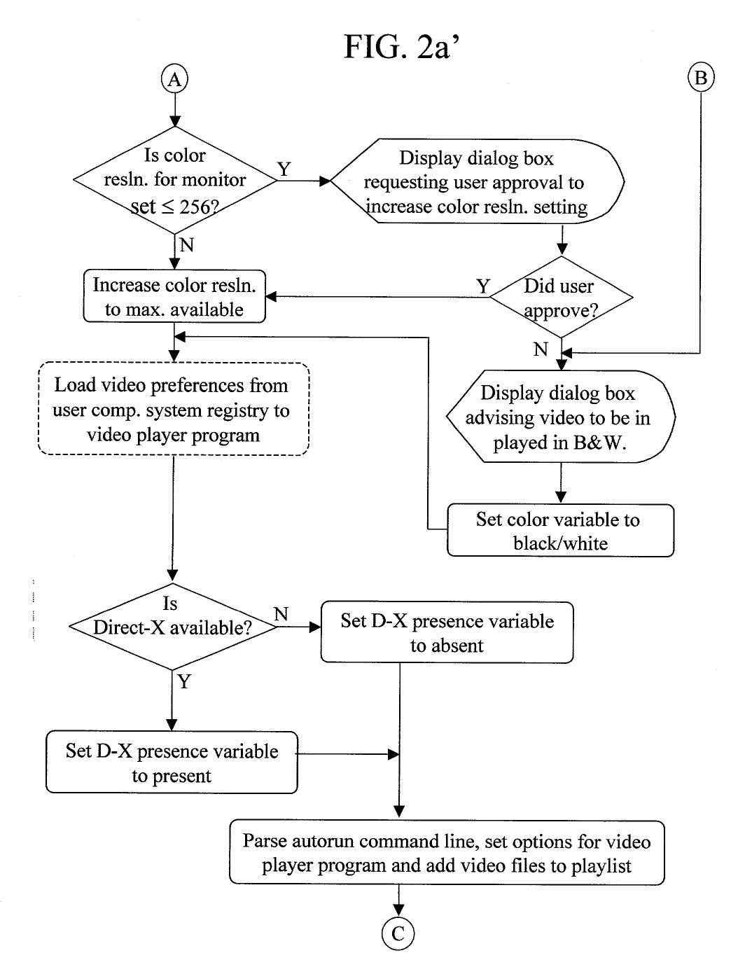

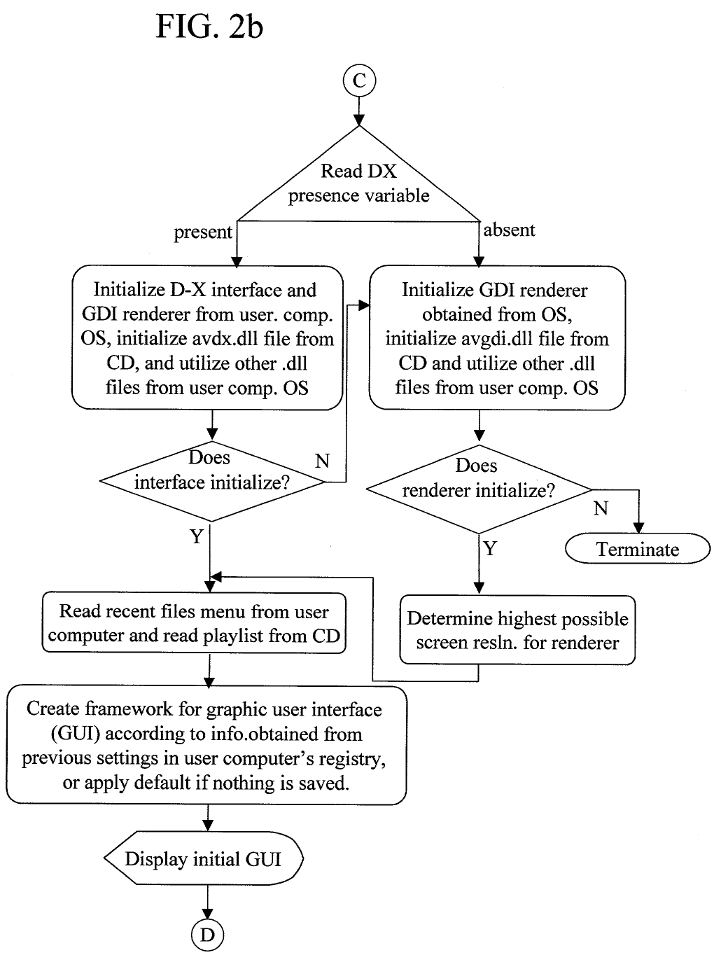

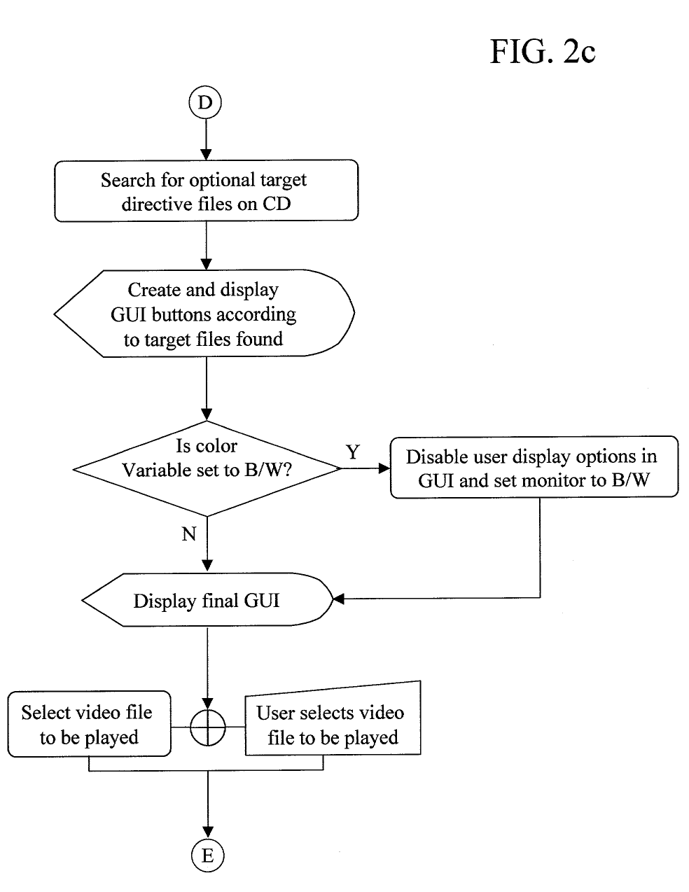

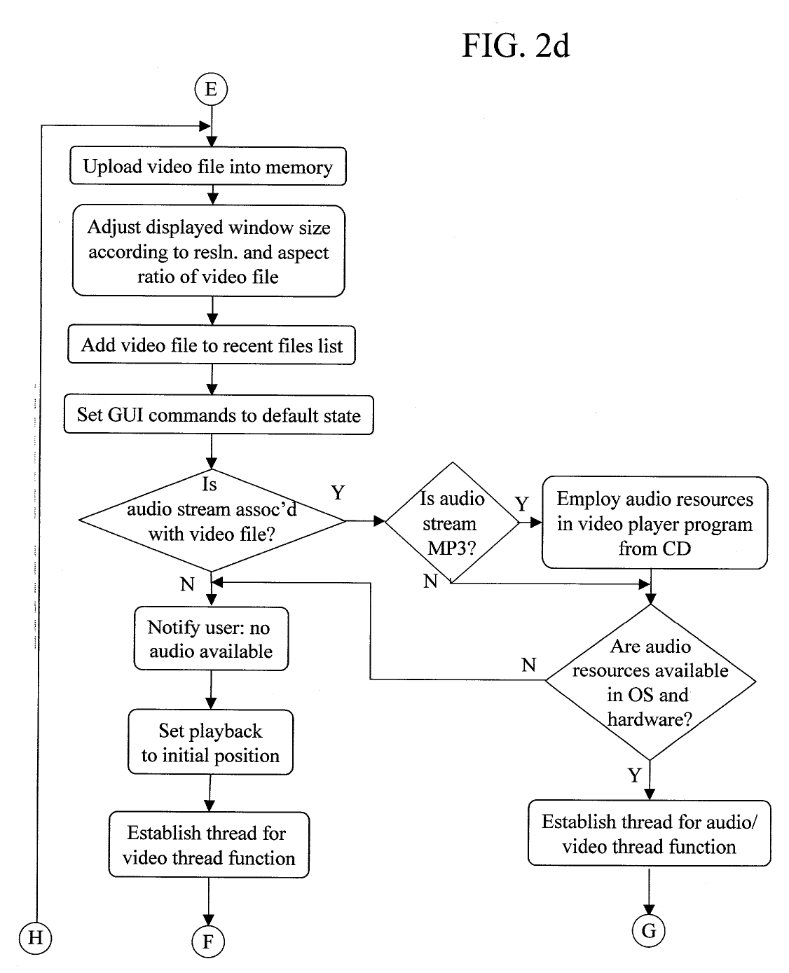

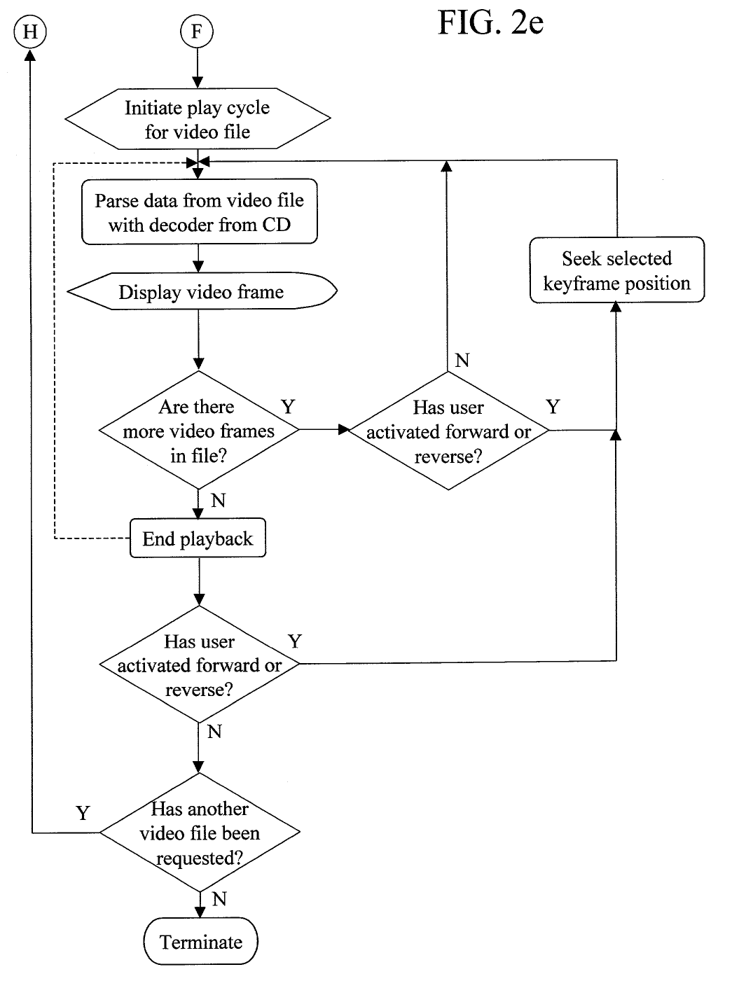

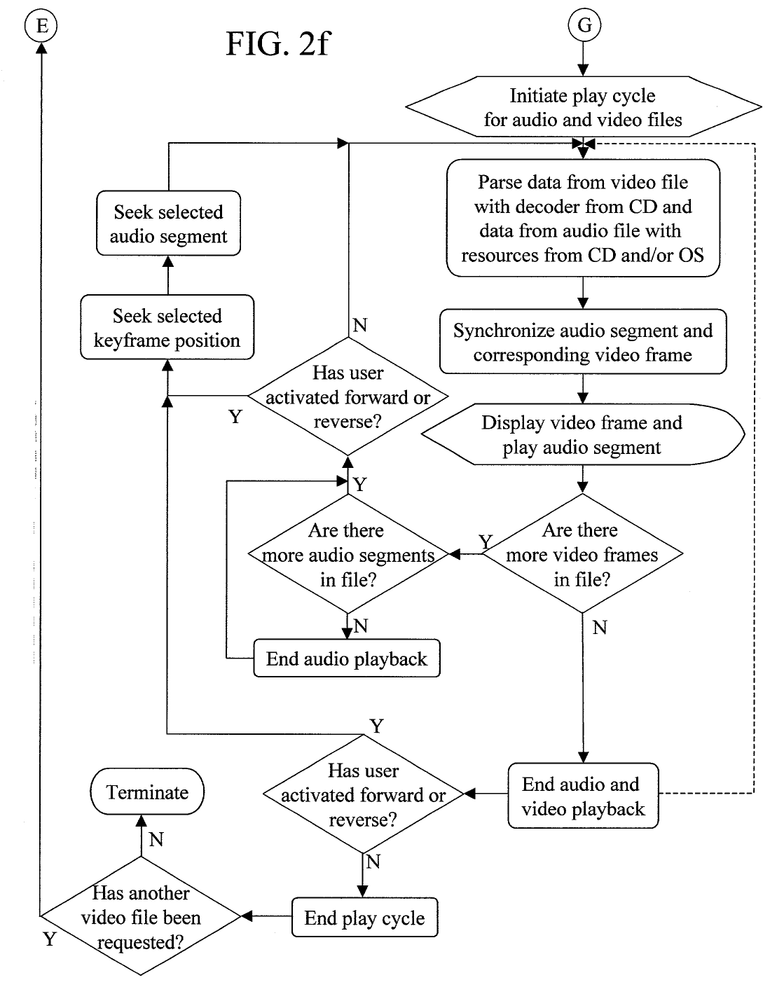

While the exemplary logic flowchart of FIG. 1 is not specific to any particular operating system environment, the logic flowchart of FIGS. 2a-2f is specific to operation under the Windows® operating system environment.

FIGS. 2a and 2a′ depict the logic flowchart of the first part of the VP application after a user computer has found a version of the VP application that is compatible with the OS of the user computer. If an AUTORUN routine is included in the CD, the AUTORUN routine initializes the VP application. If no AUTORUN routine is included in the CD, a user must initialize the VP application. After initialization, the VP application begins conducting preliminary system checks on the user computer. The VP application determines the color resolution setting and the maximum color resolution available for the display monitor. If it is set for >256 and is set for less than its available maximum, the VP application increases the color resolution to its maximum setting available. If it is set for 16-color resolution and the maximum color resolution is 16-color resolution, then the VP application is terminated. The VP application optionally generates a display box advising the user that the video player program has terminated or will terminate due to insufficient video capabilities in the user computer. If the color resolution is set to 16-color, but the maximum color resolution is 256 or higher, the VP application sets the color resolution to 256 or higher. If the color resolution is set to 256-color and the maximum color resolution is greater than 256-color, the user is shown a dialog box by way of which the VP application requests the user's permission to increase the color resolution to greater than 256-color. If 256color is determined to be the highest resolution or if the user selects 256-color as the desired color resolution, the VP application advises the user of that the video will be played in black and white, which includes grey-scale. If the process selects a color resolution that is >256, the color resolution is increased to its maximum available resolution. After the color resolution has been set, the VP application locates the required application extensions (DLL files) in the OS of the computer. The user's video preferences from the system registry of the user computer are then used as the initial settings for the video player program. The VP application then determines whether or not the DirectX® API is available in the OS of the user computer. It does this by attempting to initialize the DDRAW.DLL file. If the DDRAW.DLL file initializes properly, then the VP application sets a presence variable to indicate so, and if the DDRAW.DLL file fails to initialize properly, then the VP application sets a presence variable to indicate so, respectively. The system checks in FIGS. 2a and 2a′ can be conducted in an order different than depicted and as just described. If initialization of the DirectX® API fails, the video player program will resort to using the GDI renderer without the video enhancements of the DirectDraw® AE.

FIG. 2b depicts a continuation of the flowchart in FIG. 2a′. After the VP application has optimized the color resolution and determined the absence or presence of a predefined video enhancer application extension (the DDRAW.DLL file), a command line for the AUTORUN routine is parsed. The information obtained from the command line is used to set the options and the playlist for the VP application. The VP application then attempts to initialize the video enhancer AE, such as the DDRAW.DLL file, and it initializes the VP player AE, which is adapted to operate with the DDRAW.DLL file. It also initializes the GDI32.DLL file (an “always-present” video renderer AE present in the Windows® OS) and other “always present” AEs. In this case, the VP player AE is named the AVDX.DLL file, for example, and is obtained from the CD. If the DDRAW.DLL file fails to initialize, the VP application then initializes the GDI32.DLL file. The VP application also initializes the VP player AE that is adapted to operate with the GDI32.DLL file in the absence of the video enhancer AE, and it initializes some of the other “always present” AEs. In this case, the VP player AE is named the AVGDI.DLL file, for example, and is obtained from the CD. If initialization of the GDI32.DLL file fails, then the VP application terminates. After initialization of a VP player AE, the VP application reads the recent files menu from the OS of the user computer and reads the playlist from the CD. With the information obtained so far, e.g., the information from the previously saved settings in the registry of the user computer, the VP application uses its GUI routine to build the framework for a GUI and display an initial GUI on the monitor. If there are no stored user settings, the GUI is built using default settings.

FIG. 2c depicts a continuation of the flowchart of FIG. 2b. The VP application now searches the CD for, specifically pre-defined by code in the player, HTML files or other target content files that are viewable with a web browser program, such as Netscape Navigator®, Opera® or Internet Explorer®, or with another program, such as a presentation, graphics, word processor or database program. Exemplary HTML files include a catalog, website, survey, and index file as well as any other files that are viewable with a web browser program. If the VP application detects the presence of these HTML files, a corresponding button (active link) will be created in the GUI. For example, presence of a CATALOG.HTM file will cause creation of a “CATALOG” button, presence of a WWW.HTM file, which includes the URL address of a website, will cause creation of a “WWW” button and presence of an INDEX.HTM file, will cause creation of an “INDEX” button. If the color resolution of the display monitor has been set to black and white because nothing higher than 256 colors can be run on the video card, or because the monitor will not support a higher color resolution then the VP application plays the video in black and white and turns off color. In addition, the VP application disables the display option features in the GUI, the final GUI is displayed in black and white, and the video plays in black and white. If the color resolution has not been set to black and white, the final GUI is displayed and the video plays in color, if the video file is in color.

At this point, the video file to be played is selected. The selection can be done automatically, if the selection process has been preprogrammed into the VP application, or the selection can be done by a user employing the GUI or keyboard or voice commands.

FIG. 2d depicts a continuation of the flowchart of FIG. 2c. Following selection of the video file, it is read into the main memory of the computer. The window size of the GUI is then sized according to the resolution and aspect ratio of the video file. The name of the file to be played is added to the recent files menu and the GUI commands are set to their default. The default settings of the GUI can be set as desired when programming the VP application. For example, the GUI might be programmed to initiate playback of a video file on its own or after receiving input from a user. The VP application then determines whether or not there is audio data associated with the video file. The audio data is compiled in the video. If the video file does not have any audio data associated within it or if the audio resources of the user computer are unavailable, the VP application optionally notifies the user that audio resources are unavailable. The playback of the video file is then set to the initial position and a video thread is established.

The play cycle for the video file then begins as depicted in FIG. 2e. The video data from the video file is parsed with the video decoder from the CD and the video frame is displayed. The VP application then determines whether or not there are additional frames to be played. If there are, the VP application continues to parse video data until no more frames are available. During the play cycle, the VP application can also determine whether or not a user has activated a reverse or forward command. If so, the VP application seeks the selected keyframe and continues playback from that point in the direction chosen by the user. In other words, a video can be played in either the forward or reverse direction; although, forward is generally the default direction. Although not depicted in FIG. 2e, the VP application can also determine whether or not the user has activated the pause, stop, back-to-start, or scrub commands and will act according to the intended purpose of these commands as described above. After the play cycle of a video file is completed, the VP application determines whether or not another file has been selected. As above, this selection can be by the user or by a preprogrammed selection in the VP application itself. If no other file is to be played, the VP application is terminated. At any point along the logic flowchart, a user can also terminate the VP application by activating the appropriate command.

If the video file includes audio data or has audio data associated with it, the VP application begins to determine the requirements for playback of the audio data, as depicted in FIG. 2d. The VP application has an audio decoder included within it, so it determines whether or not the audio data is of the same format as required by the audio decoder. In this exemplary embodiment, the VP application determines whether or not the audio data is MP3 or ACM formatted, since the exemplary VP application comprises an MP3 audio decoder and can access the ACM decoder from the Windows® operating system. If it is, the VP application employs its audio decoder. If it is not, the VP application determines whether or not the user computer has the necessary audio resources, such as a compatible audio decoder and audio adapter (sound card). If the necessary audio resources are unavailable, the VP application notifies the user of the same and follows the flowchart described above for using just the video resources.

If the necessary audio resources are available, the VP application establishes an audio/video thread and initiates the playback of the audio and video data as depicted in FIG. 2f. The video data is then parsed with the decoder from the VP application, and the audio data is parsed with the decoder from the VP application or the OS of the user computer. The first audio segment to be played is synchronized in time with the corresponding first video frame to be played. Although not depicted in FIG. 2f, the synchronization is performed by computing the time difference between the current video time and the current audio time. The time difference should be zero. If the time difference is greater than zero, the video is too fast and the thread function is instructed to wait half of the time need for full synchronization. If the time difference is less than zero, the video is too slow, and the thread is instructed to drop a frame. Synchronization of the video and audio data can occur as often as needed during the play cycle. The synchronized video frame and corresponding audio segment are then outputted to their respective devices, and the VP application determines whether or not there are additional video frames and corresponding audio segments to be played. If so, the VP application continues the play cycle of the video file. If not, the audio and video playback is ended. As with the flowchart of FIG. 2f, the VP application also determines whether or not a user has activated the reverse or forward commands either during or after playback of the video file. If so, the VP application will perform as described above. After the play cycle has ended, the VP application determines whether or not another video file has been selected. If so, the next video file is read into memory, and the next play cycle is begun. If not, the VP application is terminated or returned to its default state prior to termination by a user.

The logic steps in the flowchart are not necessarily in strict order, i.e., the order of some of the steps can be changed without negatively affecting operation of the VP application.

The video player application can be installed on a user system like any other program if desired and run from there to play videos—as long as it is required VP AE file(s) is (are) installed in the same directory as the player. In this way, a user can play his own AVI video library. Alternatively, as user could setup an external scheduling program to load the video player automatically to play a series of videos such as in an in-store demo or the like.

As noted above, the logic of the VP application can be tailored for different standard API-based operating systems. For example, the Apples® OS also includes “always-present” video and audio renderer files. As with the above-described Windows® based example, these always-present files can be called upon by the VP application extensions. The always-present files are referenced by the standard API of Microsoft Windows®. Additional always-present files are used to interface with the operating system and its functions, e.g. use of mouse and keyboard, drawing windows on the screen, etc. The preferred video renderer might not installed in the Apple® OS of a user computer, or it is sometimes installed incorrectly. For this reason, the VP application, which draws upon the “always-present” files, if needed, and upon its own routines, will be useful in the Apple® OS environment and other OS environments. The methodology of interfacing with different operating systems requires the porting over of code. The programming language C++ which interfaces with the Unix™, Windows™ and Apple™ operating systems is useful for drafting the code of the VP application and its corresponding application extensions. However, when tailoring the VP application to specific operating systems, different “always present” operating system application extensions will be required by the VP application. Exemplary types of those application extensions include those required to provide mouse, keyboard, graphic and audio interfaces and/or related functions.

Regardless of the OS under which the VP application is operated, a user computer will require a video card, display monitor, optional sound card and speaker(s), and the driver software for the audio/visual hardware attached to the user computer. If some or all of the required key programs and/or application extensions are absent from the OS of the computer or are improperly installed in the user computer, the invention allows for inclusion of these components into the CD so that the VP system will still be able to play the video file obtained from the CD. The video player will play a video file in black and white if a user computer's color resolution is set to 256 color and the user does not allow the VP application to change the color resolution temporarily. If the VP application detects that 16-color resolution is the highest available resolution in the computer, then the VP application does not play the video and it notifies the user and then terminates. If the user computer's audio resources are functioning improperly, the VP application plays the video without the audio. Only the video player executable, at least one of the two dll files (the VP application extensions) and the video file to be played are required on the CD. An autorun.ini file to is optionally included in the CD to autoload the process and add parameters.

An exemplary GUI (10) that can be created with the VP application of the invention is depicted in FIG. 3. The GUI is defined by a frame (24) and a video viewing area (11) and it includes conventional GUI buttons such as the maximize window button (21), the minimize window button (22) and the close window and terminate button (23). This embodiment includes active links (buttons) for the STOP (12), PLAY (13), PAUSE (14), REVERSE (15) and FORWARD (16) commands. Since audio data is often included with video data, the exemplary GUI includes a volume control slide button (18). Also, users often enjoy viewing videos repeatedly; therefore, this GUI includes a back-to-start-of-file or restart button (17). It also includes a WWW button (25), which links to a website or local-to-CD intranet when activated, a CATALOG button (27), which brings up an HTML catalog when activated, and a SURVEY button (26), which brings up a survey which the user can fill out. All these optional HTML linkups can be configured to link and activate local or internet-based interaction. In one embodiment, the video player application auto detects an Internet (or other network) connection with the user computer and reacts according to parameters defined in the autorun.ini. The WWW, CATALOG and SURVEY buttons are included in the GUI because the CD contains corresponding HTML files that have been located by the VP application. Other buttons such as INDEX, GAME, SEARCH, or any other ones used in a network based system can also be included. For example, any reference to any html file or series of files, either locally and/or on the network, can be defined. The number of buttons is unlimited and can be menu driven. The pages that the buttons bring up can be located on the CD or user computer or on a network such as the Internet, a local area network (LAN) or an intranet. The HTML files can include the URL addresses of websites on the Internet, so that when the buttons are activated, a user computer will bring up a window for a web browser and open the requested web page. In another embodiment, a button would bring up a small pre-defined browser page. Alternatively, the VP application can play a video stream that is downloaded to the user computer at the request of a routine in the VP application. For example, the VP application could request a video file from a network server. The video file would then be downloaded to the user computer and the video player program would play the downloaded file.

A compact disc according to the invention can be included in any known packaging or shipping article such as a pocket, envelope, box, case, CD jewel case, pouch, sleeve, insert, CD holder carrying case, and other such devices known to those of ordinary skill. It can also be included in any type of hard or soft-back publication such as a magazine, book, journal, newspaper, flyer, brochure, booklet, leaflet, catalog, direct mail piece, postcard, insert, report, manual, binder, folder, and other such publications known to those of ordinary skill.

When included in a publication, the CD can be included by adhering it to the publication, inserting it in the publication, packaging it with the publication, placing it in a CD holding device in a publication or any other method known to those of ordinary skill. Exemplary methods of including the CD in a publication are disclosed in U.S. Pat. No. 5,690,220 to Swan, U.S. Pat. No. 5,186,327 to McCafferty et al., U.S. Pat. No. 5,090,561 to Spector, U.S. Pat. No. 4,850,731 to Youngs, U.S. Pat. No. 5,669,491 to Pettey, U.S. Pat. No. 5,501,326 to Shuhsiang, U.S. Pat. No. 5,290,118 to Ozeki, U.S. Pat. No. 5,275,438 to Struhl, U.S. Pat. No. 5,207,717 to Manning, U.S. Pat. No. 5,199,743 to Rosinski, U.S. Pat. No. 5,193,681 to Lievsay, U.S. Pat. No. 4,765,462 to Rose, U.S. Pat. No. 5,782,349 to Combs, U.S. Pat. No. 5,713,605 to Pace et al., U.S. Pat. No. 5,694,743 to Beighle, U.S. Pat. No. 5,590,912 to Stevens and U.S. Pat. No. 5,588,527 to Youngs, the disclosures of which are hereby incorporated by reference.

The CD can be constructed according to any known CD (DVD) and it can be flexible of rigid. Methods of preparing flexible CDs are disclosed in U.S. Pat. No. 5,579,296 to Smith et al., U.S. Pat. No. 4,965,118 to Kodera et al., U.S. Pat. No. 4,335,173 to Caraballo, U.S. Pat. No. 4,222,070 to Howe et al. and U.S. Pat. No. 3,931,459 to Korpel, the disclosures of which are hereby incorporated by reference.

The CD of the invention can be used in different applications such as being:

Inserted in a catalog or containing a catalog in HTML file format or containing an HTML file that contains an active link addressing a web page containing a catalog;

Used as a direct mail advertising piece or being attached to or packaged with a direct mail advertising piece; or

Included in a publication (e.g., magazine) as an advertising insert or being attached to or packaged with the insert.

Any type of information can be included in a target content file of the CD. For example, the CD might include a file containing an offer for a service or product. The CD could include an informational file containing information on product, such as a drug, or service, such as a medical procedure. The file could also contain instructional material, such as an instruction manual, or business information, such as a financial report. The file might also include targeted marketing information for preferred customers, such as service or product related offers for “platinum” or “gold” level customers. The file might also include a sales presentation. The CD can be used in a program for customer relationship management.

In view of the above description, one of ordinary skill in the art will be able to practice the invention as claimed without undue experimentation. The examples detail certain embodiments according to the present invention. All references made to these examples are for the purposes of illustration. The above is a detailed description of particular embodiments of the invention. It will be appreciated that, although specific embodiments of the invention have been described herein for purposes of illustration, various modifications may be made without departing from the spirit and scope of the invention. Accordingly, the invention is not limited except as by the appended claims.

What is claimed is:

1. A compact disc comprising:
a video player application comprising a video decoder routine, an audio decoder routine, a graphical user interface routine and a video performance optimization routine;
one or more video player application extensions that include video and audio rendering interface functions; and
one or more video files.

2. The compact disc of claim 1 further comprising an autorun routine that initializes the video player application after loading of the compact disc into a user computer.

3. The compact disc of claim 1, wherein the video performance optimization routine comprises functions to analyze the hardware, software and settings of the user computer into which the compact disc is installed.

4. The compact disc of claim 3, wherein the video performance optimization routine determines the presence or absence of a predefined video enhancer application extension in the OS of a user computer into which the compact disc is loaded.

5. The compact disc of claim 1, wherein the one or more video player application extensions comprises a first video player application extension for use when a predefined video enhancer is present in the OS of a user computer into which the compact disc is loaded and a second video player application extension for use when the predefined video enhancer is absent from the OS of a user computer into which the compact disc is loaded.

6. The compact disc of claim 5, wherein the first video player application extension references a DirectDraw component of the DirectX® API and references a GDI video renderer, and the second video player application extension references a GDI video renderer.

7. The compact disc of claim 1 further comprising one or more target content files.

8. The compact disc of claim 7, wherein the graphical user interface routine comprise a function to create, in a graphical user interface, one or more active buttons corresponding to the one or more target content files when the video player program is running on a user computer.

9. The compact disc of claim 1, wherein the video player application is adapted to run on a computer operating under a Windows® operating system environment.

10. The compact disc of claim 1, wherein the video player application is adapted to run on a computer operating under an Apple® operating system environment.

11. The compact disc of claim 1, wherein the video player application is adapted to run on a computer operating under a Unix® operating system environment.

12. The compact disc of claim 1, wherein the video player program is written in C++ programming language.

13. The compact disc of claim 1, wherein at least one of the one or more video player application extensions comprises an import request for an always-present video renderer application extension.

14. The compact disc of claim 13, wherein the video player application comprises import requests for one or more other always-present application extensions in the operating system of a user computer into which the compact disc is loaded.

15. The compact disc of claim 14, wherein the one or more video player application extensions comprises:
a) a first video player application extension that comprise an import request for a video enhancer application extension and a video renderer application extension;
b) a second video player application extension that comprises an import request for a video renderer application extension.

16. The compact disc of claim 15, wherein the first and second video player application extensions each further comprises an import request for an audio renderer application extension.

17. The compact disc of claim 15, wherein the first video player application extension further comprises an import request for an audio enhancer application extension.

18. A compact disc adapted to being played in a computer operating under the Windows® operating system environment, the compact disc comprising:
a) a video player application comprising a video decoder routine, an audio decoder routine, a graphical user interface routine, and a video performance optimization routine;
b) an optional first DLL file comprising import requests for the DDRAW.DLL, DDRAWEX.DLL or DDRAW16.DLL file and the DSOUND.DLL or DSOUND3D.DLL file of the DirectX API, MSACM32.DLL file and for the GDI32.DLL file of the Windows® operating system;
c) a second DLL file comprising import requests for the GDI32.DLL file of the Windows® operating system; and
d) one or more video files;
e) wherein the first and second DLL files comprise video rendering related functions.

19. The compact disc of claim 18 further comprising one or more target content files.

20. The compact disc of claim 19, wherein the graphical user interface routine comprise functions to create, in a graphical user interface, at least one button corresponding to the one or more target content files.

21. The compact disc of claim 18, wherein the first DLL file is present.

22. The compact disc of claim 21, wherein each of the first and second DLL files further comprises at least one import request for one or more always-present DLL files in the Windows® operating system.

23. The compact disc of claim 22, wherein the at least one import request for one or more always-present DLL files comprises import requests for the WINMM.DLL, KERNEL32.DLL, and USER32.DLL files or equivalents thereof.

24. The compact disc of claim 22, wherein the compact disc further comprises an autorun routine that initializes the video player application when the compact disc is loaded into a user computer.

25. The compact disc of claim 22, wherein the video decoder routine uses a video resource selected from the group consisting of MPEG-1, MPEG-2 and MPEG-4.

26. The compact disc of claim 22, wherein the audio decoder routine uses an audio resource selected from the group consisting of MP3 and ACM.

27. The compact disc of claim 18, wherein the video player application comprises a routine to determine if target content files are located in the disc.

28. The compact disc of claim 18, wherein the video player application comprises a routine that determines whether or not the DDRAW.DLL, DDRAWEX.DLL or DDRAW16.DLL file is present in the operating system of a user computer into which the compact disc is loaded.

29. The compact disc of claim 28, wherein the video player application comprises a routine that determines whether or not the DSOUND.DLL, MSACM32.DLL or DSOUND3D.DLL file is present in the operating system of a user computer into which the compact disc is loaded.

30. The compact disc of claim 29 further comprising audio data.

31. The compact disc of claim 23 further comprising one or more target content files and an autorun routine.

32. A video player system comprising:
a) a compact disc comprising a video player application, at least one video player application extension that provides video rendering interface related functions accessible by the video player application when running, and at least one video file to be played, wherein the video player application comprises a video decoder routine, audio decoder routine and graphical user interface routine, and at least one of the video player application extensions is adapted to draw upon a predefined video renderer application extension in the operating system of a user computer into which the compact disc is loaded; and
b) a user computer comprising an operating system, video adapter, display monitor, and optional audio adapter, wherein the operating system comprises a predefined video renderer application extension accessible to the at least one video player application extension;
c) wherein the video player application operates without requiring installation of any files into the operating system of the user computer.

33. The video player system of claim 32, wherein the user computer optionally comprises a predefined video enhancer application extension, and the at least one video player application extension comprises a first video player application extension for use when a first predefined video enhancer application extension is present in the OS of the user computer, and a second predefined video player application extension for use when the first predefined video enhancer application is absent from the OS of the user computer.

34. The video player system of claim 33, wherein the first predefined video enhancer application extension is the DirectDraw® application extension and the predefined video renderer application extension is the GDI application extension.

35. The video player system of claim 33, wherein each of the first and second video player application extensions comprises import requests for always-present application extensions in the operating system of the user computer.

36. The video player system of claim 33, wherein the video player application comprises a routine that determines whether or not the first predefined video enhancer is present in the operating system of the user computer.

37. The video player system of claim 32, wherein the video player application further comprises a video performance optimization routine.

38. The video player system of claim 32, wherein the operating system of the user computer further comprises at least one audio renderer application extension.

39. The video player system of claim 32, wherein the compact disc further comprises an autorun routine that initializes the video player application when the compact disc is loaded into the user computer.

40. The video player system of claim 32, wherein the video decoder routine uses a video resource selected from the group consisting of MPEG-1, MPEG-2 and MPEG-4.

41. The video player system of claim 32, wherein the audio decoder routine uses an audio resource selected from the group consisting of MP3 and ACM.

42. The video player system of claim 32, wherein the video player application further comprises a routine that determines whether or not the predefined video renderer application extension is present in the operating system of the user computer.

43. The video player system of claim 42, wherein the video player application further comprises a routine that determines whether or not a predefined video enhancer application extension is present in the operating system of the user computer

44. The video player system of claim 43, wherein the video player application further comprises a routine to determine if target content files are located in the disc.

45. The video player system of claim 32, wherein the compact disc further comprises audio data.

46. The video player system of claim 32, wherein the compact disc further comprises target content files.

47. The video player system of claim 46, wherein the GUI routine comprises functions to create one or more buttons or active links associated with the target content files.

48. The video player system of claim 35, wherein the video player application further comprises a video performance optimization routine, and the operating system of the user computer further comprises an audio renderer application extension and a video enhancer application extension.

49. The video player system of claim 48, wherein the compact disc further comprises one or more target content files.

50. A method of playing one or more video files on a compact disc, the method comprising the steps of:
a) a user computer running a video player application obtained from a compact disc containing video files to be played, wherein the video player application is not installed in the operating system of the hard disk of the user computer;
b) the video player application determining the optimum video performance parameters for playing the video file(s) by analyzing a portion of the content of the compact disc, by analyzing the some of the hardware, software and settings of a user computer into which the compact disc has been installed (loaded), and optionally by determining the presence or absence of a predefined video enhancer application extension in the operating system of the user computer;
c) initializing a predefined always-present video renderer application extension present in the operating system of the user computer, and, if present, initializing the predefined video enhancer application extension;
d) initializing a video player application extension obtained from the compact disc and initializing other predefined always-present application extensions obtained from the operating system of the user computer, wherein the video player application extension from the compact disc is adapted for use with the predefined video renderer application extension that is initialized and optionally adapted for use with the predefined video enhancer application extension, if present;
e) initializing a video decoder routine from the video player application, and optionally initializing an audio decoder routine from the video player application or from the operating system of the user computer;
f) defining and creating a graphical user interface, wherein definition of the GUI depends upon the determined optimum video performance parameters; and
g) reading and playing one or more video files obtained from the compact disc comprising the video player application.

51. The method of claim 50 further comprising the step of initializing the video player application by way of an autorun routine.

52. The method of claim 50, wherein the step of determining the optimum video performance parameters comprises the step of setting the color resolution of the display monitor to a determined setting.

53. The method of claim 50, wherein the step of defining and creating a graphical user interface comprises the steps of: creating a framework for a GUI according to information obtained from the registry entries in the operating system of the user computer; optionally, searching for one or more target content files on the CD and creating one or more GUI buttons associated with said target content files, if present; and displaying a GUI.

54. The method of claim 50, wherein the step of reading and playing one or more video files comprises the steps of: selecting a video file to be played; reading the video file into memory; optionally determining whether or not audio data is associated with the video file; establishing a process thread for the video thread function if there is no audio data associated with the video file or establishing a process thread for the video/audio thread function if there is associated audio data; initiating the play cycle of the video file and optionally of the audio data, if present; displaying the video file frames and optionally in synchronization outputting the corresponding audio data segments, if present; ending the play cycle of the video file; and optionally determining whether or not another video file has been selected for playing.

55. The method of claim 54 further comprising the step of repeatedly playing the video file and associated audio data, if present.

56. The method of claim 50 further comprising the step of determining whether or not the user has activated forward or reverse commands, and if so, seeking the selected video keyframe position and selected audio segment, if any.

57. The method of claim 50 further comprising the step of terminating the video player application if no additional video file is to be played.

58. The method of claim 50 further comprising the step of determining whether or not the user has activated the stop, back-to-start or pause commands.

59. The method of claim 52, wherein
a) the step of determining the optimum video performance parameters comprises the step of setting the color resolution of the display monitor to a determined setting;
b) the step of defining and creating a graphical user interface comprises the steps of: creating a framework for a GUI according to information obtained from the registry entries in the operating system of the user computer; optionally, searching for one or more target content files on the CD and creating one or more GUI buttons associated with said target content files, if present; and displaying a GUI; and
c) the step of reading and playing one or more video files comprises the steps of: selecting a video file to be played; reading the video file into memory; optionally determining whether or not audio data is associated with the video file; establishing a process thread for the video thread function if there is no audio data associated with the video file or establishing a process thread for the video/audio thread function if there is associated audio data; initiating the play cycle of the video file and optionally of the audio data, if present; displaying the video file frames and optionally in synchronization outputting the corresponding audio data segments, if present; ending the play cycle of the video file; and optionally determining whether or not another video file has been selected for playing.

60. The method of claim 59, wherein the predefined video enhancer application extension is present in the OS of the computer, and the video file has audio data associated with it.

61. The method of claim 59, wherein one or more target content files are present.

62. The method of claim 59 further comprising the step of initializing the video player application by way of an autorun routine.

63. A hard or soft-back publication comprising a compact disc according to claim 1, 2, 5, 7-15, 18-19, 21-24, 28 or 29.

64. A packaging or shipping article comprising a compact disc according to claim 1, 2, 5, 7-15, 18-19, 21-24, 28 or 29.
